(19) United States
(12) Patent Application Publication
(10) Pub. No.: US 2003/0118756 A1
(43) Pub. Date: Jun. 26, 2003

(54) Three-dimensional jigsaw puzzle

(76) Inventor: Shih-Hung Chuang, Yungho City (TW)

Correspondence Address: VENABLE, BAETJER, HOWARD AND CIVILETTI, LLP, P.O. BOX 34385, WASHINGTON, DC, 20043-9998, US

(21) Appl. No.: 10/025,494

(22) Filed: Dec. 26, 2001

(51) Int. Cl. B32B 3/10

(52) U.S. Cl. 428/33

(57) ABSTRACT

A three-dimensional jigsaw puzzle is disclosed. The jigsaw puzzle has a skin with a picture painted on a surface thereof. The skin is formed by a plurality of pieces. A semitransparent bladder is provided inside the skin. The bladder has a pattern the same as the picture with contours of the pieces and an electrical light bulb provided therein. When the bulb is actuated, the pattern can be seen.

### BACKGROUND OF THE INVENTION

1. Field of the Invention

The present invention is related to a jigsaw puzzle, and more particularly to a three-dimensional jigsaw puzzle.

2. Description of Related Art

Jigsaw puzzles are popular toys for children and even adults. Conventional jigsaw puzzles generally are planar pictures which have cut up into pieces, and then the pieces are fitted together to recreate the pictures again. The quantities of pieces in puzzles can be varied by manufacturers so that assorted difficulty levels in doing the puzzles are achieved in order satisfy consumer demands.

There have been some jigsaw puzzles invented that are called three-dimensional puzzles. One of the three dimensional puzzles is composed of cubic pieces that each have six surfaces painted with various patterns and that can be recombined to form six pictures corresponding to the respective surfaces of the cubic pieces.

Another three-dimensional jigsaw puzzle has a dimensional frame being composed of horizontal brackets and vertical brackets. The brackets have a plurality of apertures defined therein. Puzzle pieces with poles can be mounted on the brackets by the poles being inserted in the apertures to form a three-dimensional shape.

In a third three-dimensional jigsaw puzzle, there are a plurality of sheets painted with the same picture. The sheets are cut up according to the pieces of the jigsaw puzzle. The pieces are respectively adhered with the sheets having different numbers. Whereby, the pieces have different thicknesses and the picture reformed by the pieces has a three-dimensional effect.

However, all the conventional jigsaw puzzles have two-dimensional pictures combined by the pieces. There is no true three-dimensional effect in the jigsaw puzzles.

Therefore, the invention provides an improved jigsaw puzzle to mitigate and/or obviate the aforementioned problems.

### SUMMARY OF THE INVENTION

The main objective of the invention is to provide a jigsaw puzzle which has a true three-dimensional effect.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a three-dimensional jigsaw puzzle in accordance with the invention;

FIG. 2 is a cross sectional view of the jigsaw puzzle in FIG. 1; and

FIG. 3 is another embodiment of the present invention shown in FIG. 1.

### DETAILED DESCRIPTION OF THE PREFERRED EMBODIMENT

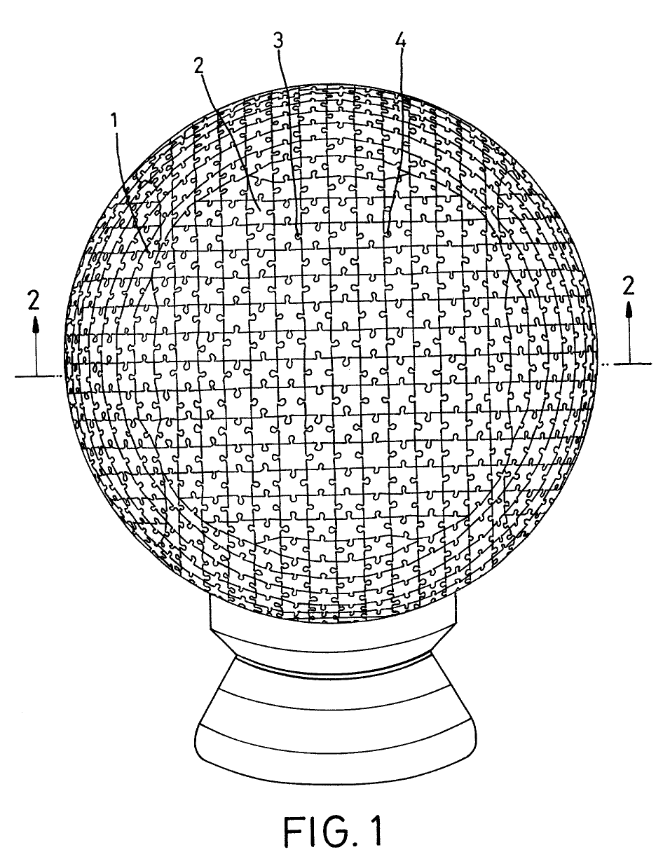

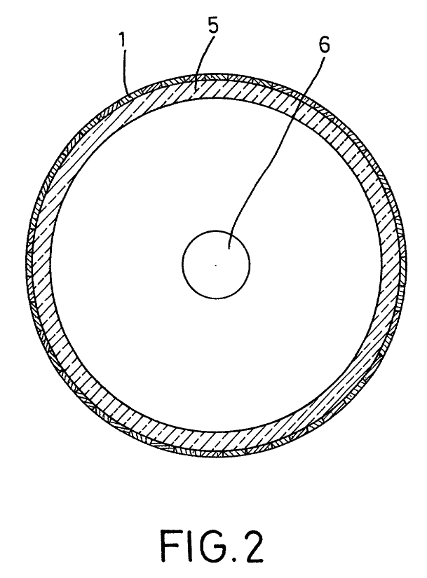

Referring to FIGS. 1 and 2, a three-dimensional jigsaw puzzle in accordance with the invention is composed of a semitransparent bladder (5), a skin (1) mounted around the semitransparent bladder (5), an electric light bulb (6) received inside the bladder (5) and connectable with an electricity supply, and a stand on which the bladder (5), skin (1), and bulb (6) are mounted.

The skin (1) with an even thickness has a picture painted on an outer surface thereof and is cut up into a plurality of pieces (2). Adjacent pieces (2) have matched protrusions (3) and cutouts (4) formed at edges thereof. The protrusions (3) and cutouts (4) can be C-shaped or other shapes. In reforming the picture on the skin (1), the pieces (2) are stayed on the bladder (5) and the protrusions (3) are received in the matched cutouts (4) to ensure that the pieces (2) are stably combined together.

Because the pieces (2) each have a curved surface, in reforming the puzzle, a user needs to combine the pieces not only according to the picture, but also the three-dimensional shapes of pieces. Thus the difficulty of reforming the sphere (1) is higher than the conventional puzzles. Furthermore, the reformed jigsaw puzzle is also a favorable three-dimensional decoration that can be displayed as an ornament.

Moreover, a pattern the same as the picture with contours of the pieces (2) is painted on an inner surface of the bladder (5). When the bulb (6) which is provided in the bladder (5) is actuated, the contours of the pieces (2) can be seen. If the user feels the puzzle is too difficult to reform, the bulb (6) can be actuated and the skin (1) then is reformed according to the contours of the pieces (2). Thus, by the illumination of the bladder (5) the difficulty level is lowered.

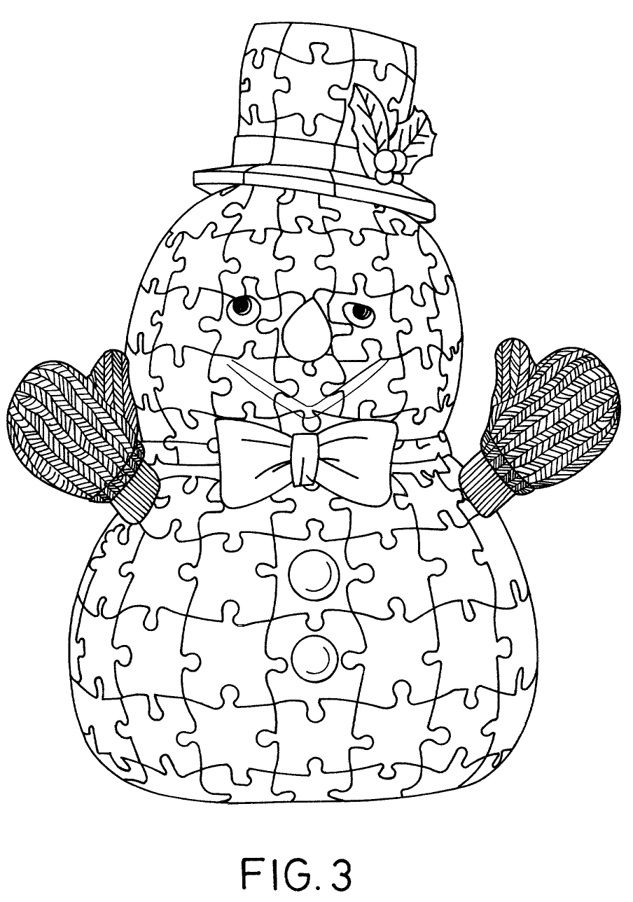

With reference to FIG. 3, another embodiment of the present invention is shown and is designed to be a snow man.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A three-dimensional jigsaw puzzle, comprising:
a bladder (5);
a skin (1) mounted outside the bladder (5), the skin (1) having a picture painted on an outer surface thereof, and being composed of a plurality of pieces (2),
whereby, when the pieces (2) are stayed on the bladder (5) and correctly fitted together, the skin (1) is reformed.

2. The three-dimensional jigsaw puzzle as claimed in claim 1, wherein the skin (1) has an even thickness.

3. The three-dimensional jigsaw puzzle as claimed in claim 1, wherein adjacent pieces (2) have matched protrusions (3) and cutouts (4) formed at edges thereof.

4. The three-dimensional jigsaw puzzle as claimed in claim 3, wherein the protrusions (3) and the cutouts (4) can be C-shaped.

5. The three-dimensional jigsaw puzzle as claimed in claim 1, wherein the bladder (5) is semitransparent.

6. The three-dimensional jigsaw puzzle as claimed in claim 5, wherein the bladder (5) has a pattern the same as the picture with contours of the pieces (2) and painted on an inner surface of the bladder (5).

7. The three-dimensional jigsaw puzzle as claimed in claim 6, further comprising an electrical light bulb (6) received inside the bladder (5) and connectable with an electricity supply.
